(19) United States
(12) Patent Application Publication
(10) Pub. No.: US 2025/0383324 A1
(43) Pub. Date: Dec. 18, 2025

(54) DETERMINATION OF SPEEDS OF SOUND IN MEDIA

(71) Applicant: DarkVision Technologies Inc., North Vancouver (CA)

(72) Inventors: Carlos Alberto da Costa Filho, North Vancouver (CA); Derrell D'Souza, North Vancouver (CA)

(21) Appl. No.: 19/235,637

(22) Filed: Jun. 12, 2025

(30) Foreign Application Priority Data
Jun. 14, 2024 (GB) 2408611.8

(51) Int. Cl. G01N 29/30; G01N 29/06; G01N 29/28; G01N 29/32

(52) U.S. Cl. CPC G01N 29/30; G01N 29/0654; G01N 29/28; G01N 29/323; G01N 29/326

(57) ABSTRACT

A non-destructive testing device with an ultrasonic transducer array inspects objects carrying a fluid. Ultrasound reflections are stored in the device and processed to create images of the object. A processor estimates the speed of sound of the fluid by trying values for the sound speed and for each value: makes images from the reflections, calculate geometric parameters for the object from the images, and calculate a metric for how much the parameters vary. The estimated speed of sound is associate with the optimized metric.

### TECHNICAL FIELD

The disclosure pertains to the field of acoustics. Aspects of the disclosure relate to methods of operation of an ultrasonic transducer array including receiving ultrasonic signals propagating through a medium from a tubular and using geometric parameters from the tubular to determine physical properties of the medium and tubular.

### BACKGROUND

Inspection devices are often deployed in conduits, wellbores, pipes, and other confined spaces to inspect the condition of the enclosure. For example, hydrocarbons in production casings may contaminate groundwater if there are cracks or deformations in the casing. A water or oil pipeline above ground may have defects that lead to a leak. High-resolution images of the enclosing structure are helpful to many technical processes that detect such defects, which may require intervention to fix.

Ultrasonic imaging is a common technique to inspect such targets and uses the fluids carried therewithin to transmit the acoustic waves and reflections. However, creating high-resolution images relies on an accurate knowledge of the speed of sound of that fluid, which can only be estimated from a guess at the fluid in different parts of the tubular.

### SUMMARY

A method of operation for an ultrasonic inspection system, the method including transmitting a plurality of ultrasonic pulses in a plurality of directions from an ultrasonic transducer array and receiving a plurality of reflections from a target. A respective reflection in the plurality of reflections corresponds to at least one respective pulse in the plurality of pulses. For a plurality of trial values for the speed of sound, and until a termination condition is met, the method includes selecting an instant trial value from amongst the plurality of trial values for the speed of sound, creating a plurality of images from the plurality of reflections and the instant value from the plurality of trial values for the speed of sound, wherein a respective image corresponds with a respective direction in the plurality of directions, extracting from the plurality of images a plurality of geometric parameters for the target, and computing a deviation metric amongst the plurality of geometric parameters. The method further includes returning an optimal value for the speed of sound from amongst the plurality of trial values for the speed of sound, wherein the optimal value for the speed of sound optimizes the deviation metric.

A system for ultrasonic inspection comprising an inspection probe having an ultrasonic transducer array and on-tool processor programmed to cause the ultrasonic transducer array to: a) transmit a first plurality of ultrasonic pulses in a first plurality of directions; b) receive a first plurality of reflections from a first sector of a target, wherein a respective reflection in the first plurality of reflections corresponds to at least one respective pulse in the first plurality of ultrasonic pulses; and c) store the first plurality of reflections. The system comprises at least one non-transitory storage device communicatively coupled to at least one processor and which stores processor-executable instructions, which cause the at least one processor to iterate over at least two trial values for the speed of sound and in each respective iteration: i) select an instant trial value for the speed of sound from amongst the at least two trial values for the speed of sound, ii) create a plurality of images from the first plurality of reflections and the instant trial value from the speed of sound, wherein a respective image corresponds with a respective direction in the first plurality of directions, iii) extract from the plurality of images a plurality of geometric parameters for the first sector of the target, and iv) compute a deviation metric amongst the plurality of geometric parameters.

The storage device stores processor-executable instructions which when executed cause the ultrasonic transducer array to transmit a first plurality of ultrasonic pulses in a first plurality of directions, and receive a first plurality of reflections from a first sector of a target. A respective reflection in the first plurality of reflections corresponds to at least one respective pulse in the first plurality of pulses. The storage device stores processor-executable instructions which when executed cause the at least one processor to iterate over at least two trial values for the speed of sound. In each respective iteration, the instructions cause the processor to select an instant trial value for the speed of sound from amongst the at least two trial values for the speed of sound, and create a plurality of images from the first plurality of reflections and the instant trial value from the speed of sound. A respective image corresponds with a respective direction in the first plurality of directions. In each respective iteration, the instructions cause the processor to extract from the plurality of images a plurality of geometric parameters for the first sector of the target, and compute a deviation metric amongst the plurality of geometric parameters.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Systems, devices, articles, and methods are described in greater detail herein with reference to the following figures in which:

FIG. 1 is a technical diagram illustrating, in perspective view, an inspection tool including an ultrasound transducer array in proximity with a tubular;

FIG. 2 is a technical diagram illustrating, in a sectional view, an inspection tool having several ultrasound transducer arrays;

FIG. 3 illustrates, in a schematic view, a plurality of circuits for use with the probe;

FIG. 4 illustrates, a flow chart, an implementation of a method of operation of a probe;

FIG. 5 illustrates an implementation of a method of operation of a probe;

FIG. 6 illustrates an implementation of a method of operation of a probe;

FIG. 7A and FIG. 7B illustrate implementations of method of operation of a probe;

FIG. 8 illustrates examples of geometric features extracted from an image formed from reflections received by a probe; and

FIG. 9A and FIG. 9B illustrate examples of deviation metrics over a plurality of trial values for the speed of sound.

In the drawings, the same reference numbers identify similar elements or acts. In the drawings, angle, size, and relative position of elements are not necessarily shown to scale. For example, some of these elements may be enlarged or positioned to improve drawing legibility. Further, the shapes of any elements as drawn, are not necessarily intended to convey any information regarding the actual shape of the particular elements and may have been solely selected for ease of illustration or recognition.

### DETAILED DESCRIPTION

Ultrasonic inspection of tubulars, such as pipelines, liners and casings, requires a coupling liquid, typically the oil or water flowing in the tubular. Accurate determination of the speed of sound (SoS) affects the quality of images and other concrete results generated from data collected by an ultrasound probe. However, not only are the liquids comprised of uncertain components, the instantaneous SoS of the assumed liquid may vary throughout the length of the tubular. Indeed, an incorrect assumption of the speed of sound affects the usefulness of a probe used in commercial, safety, and technical scenarios such as In-Line Inspections (ILI). Incorrect speed of sound values introduces geometrical distortions, misplaces tubulars in reconstructions of the space, or otherwise hinders accurate characterization of the tubular's structure or material properties. In this technical process, flaws may be mischaracterized in nature, size, and location or missed altogether.

The applicant appreciates that the process to beamform, generating visual representations of the physical distribution of acoustic signals (e.g., reflections), is a technical activity using specialized apparatuses and methods. The applicant further appreciates that other novel and inventive methods have failed including one based on overall image similarity. Applicant tested a plurality of velocity values that maximize a similarity metric between a plurality of beamformed images acquired using different transmit angles. The transmit directions of signals (equivalently the normal to the wavefronts of the signal) emitted by a transducer array is a plurality of angles. The hypothesis is that at the true SoS velocity, the metric shows maximal alignment and consistency of the spatial information in the images regardless of the transmit angle.

The results were unexpectedly disappointing. Exemplary metrics include cosine similarity on various aspects of the image, e.g., the real part, or envelope of the complex beamformed images. The process includes the calculation of a normalized inner product between two images. In the case of three transmit angles (for example, −20°, 0°, +20°), the applicants tested a similarity metric based on the average of the pairwise similarities between images corresponding to different angles. For some pairs of transmit angles widely differing in direction, the pairwise metrics were excluded from the average. This method, e.g., with cosine similarity, did not work for the following suspected reasons or conditions: low signal-to-noise in the images, the presence of image artifacts, when the aperture is limited, or when there are other nearer unexpected tubulars in view. Further, the method didn't produce a sufficiently strong gradient to allow for automated or adaptive techniques.

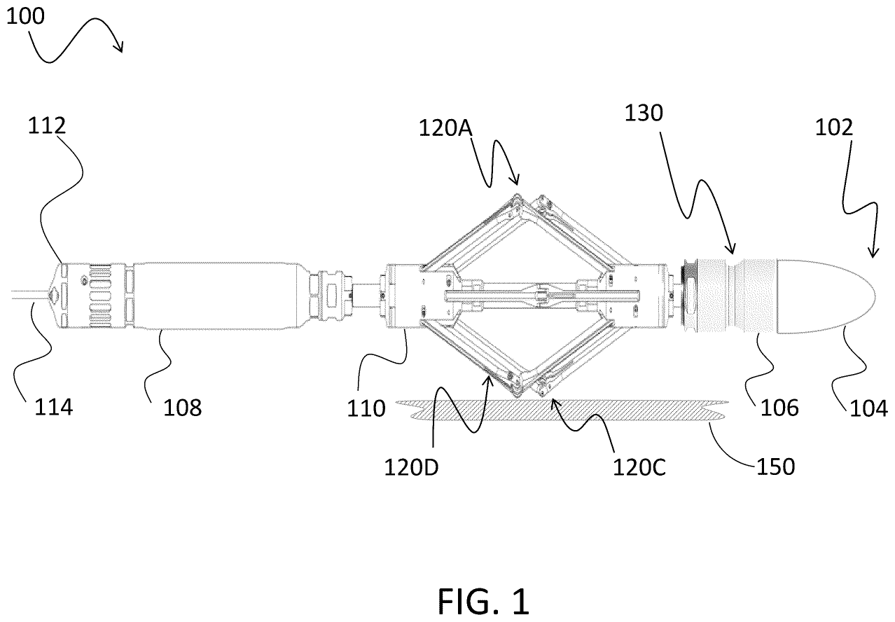

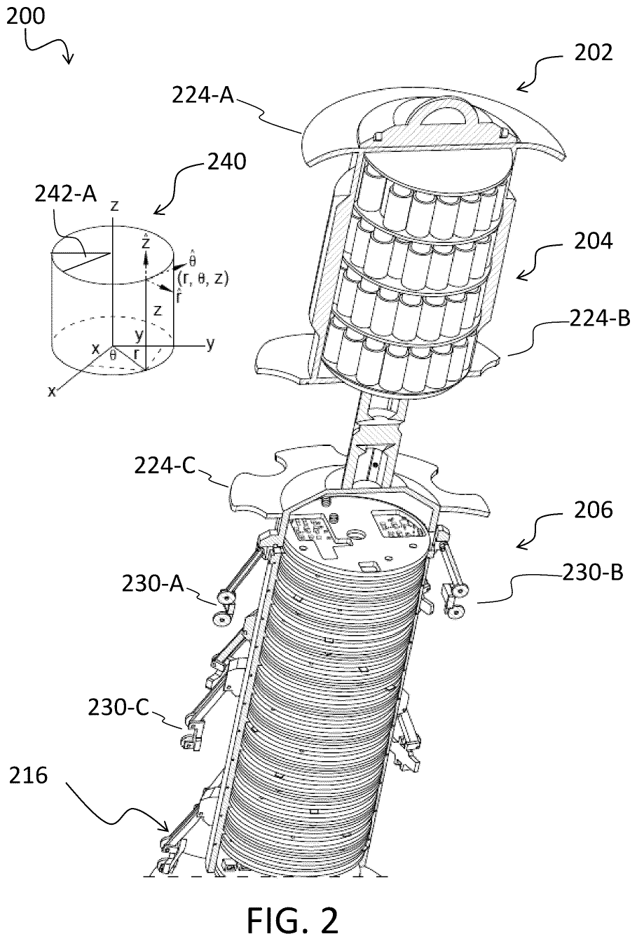

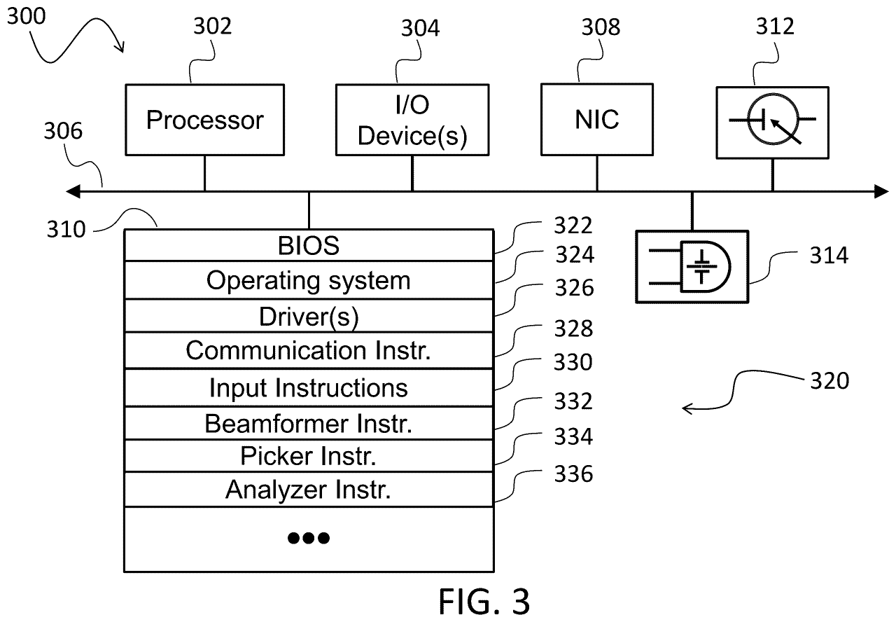

As will be explained in detail in the drawings and accompanying text (e.g., description, claims) applicant has presented novel and technical systems, devices, articles of manufacture, and methods to determine the speed of sound and improve the operation of ultrasonic probes. Looking at the drawings in overview, note the following. FIG. 1 illustrates a probe 100 including a transducer array. FIG. 2 illustrates the transducer array and an enclosed space. FIG. 3 illustrates a plurality of circuits for use in probe 100.

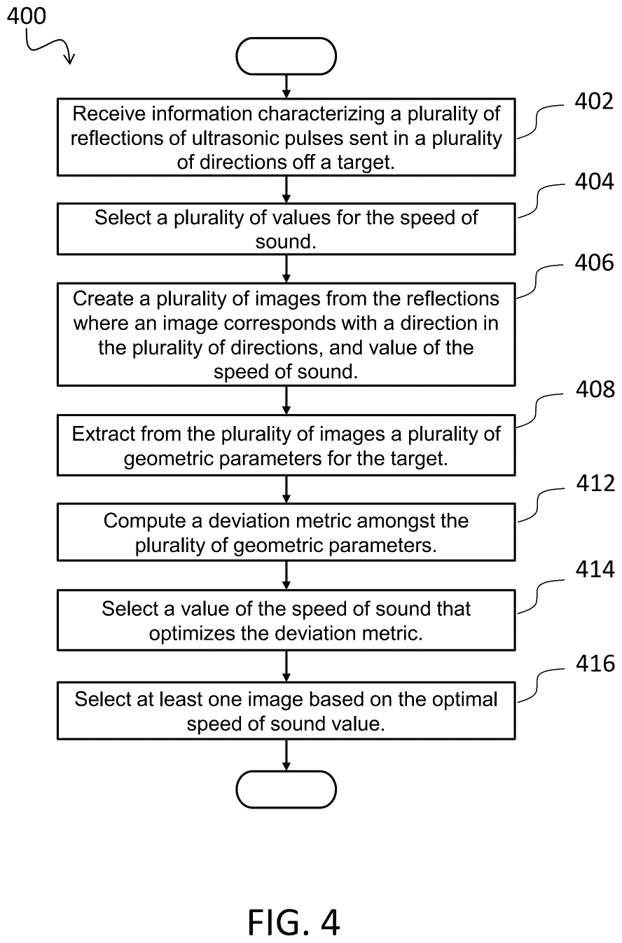

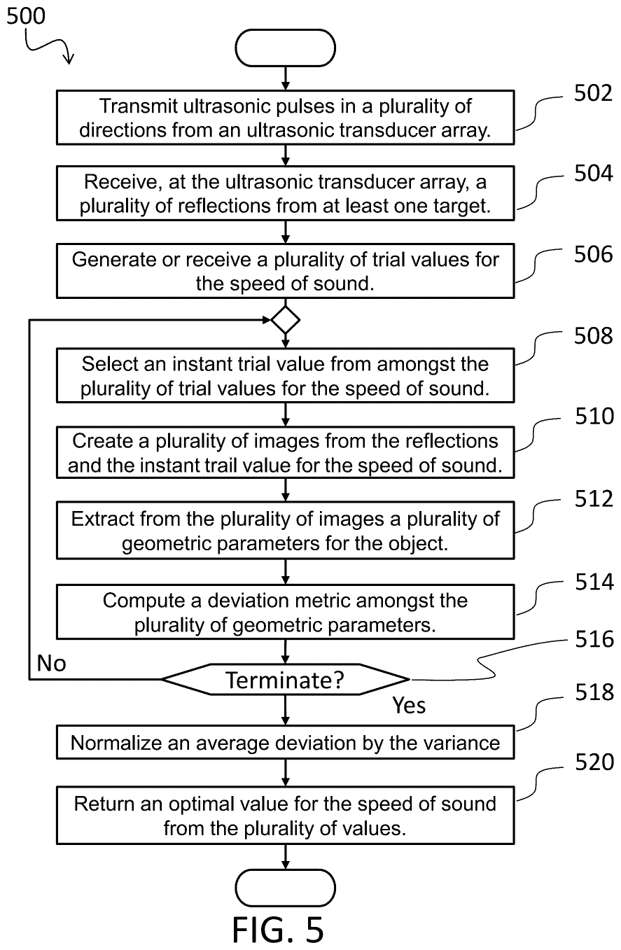

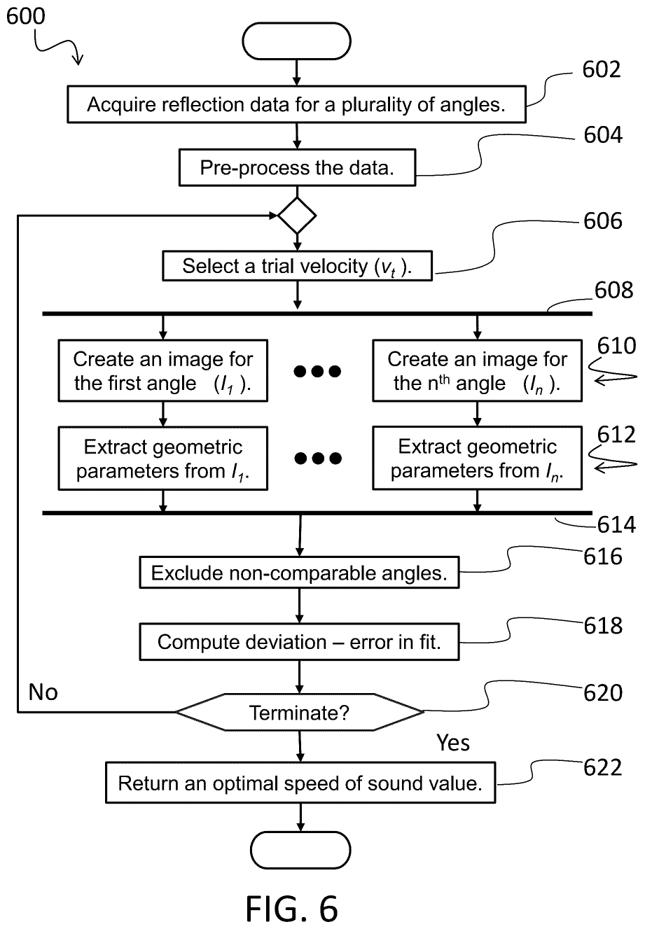

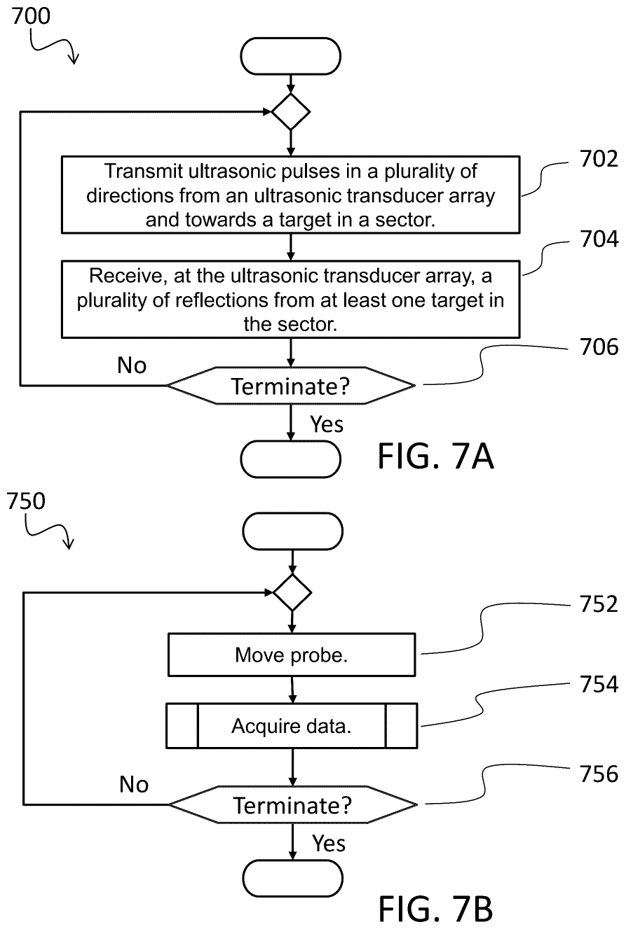

Various drawings illustrate aspects of the operation of a probe and a processor-based device. Looking at the drawings in overview, note the following. FIG. 4, FIG. 5, FIG. 6, and FIG. 7 illustrate example methods for use with a probe such as a probe including an ultrasonic array.

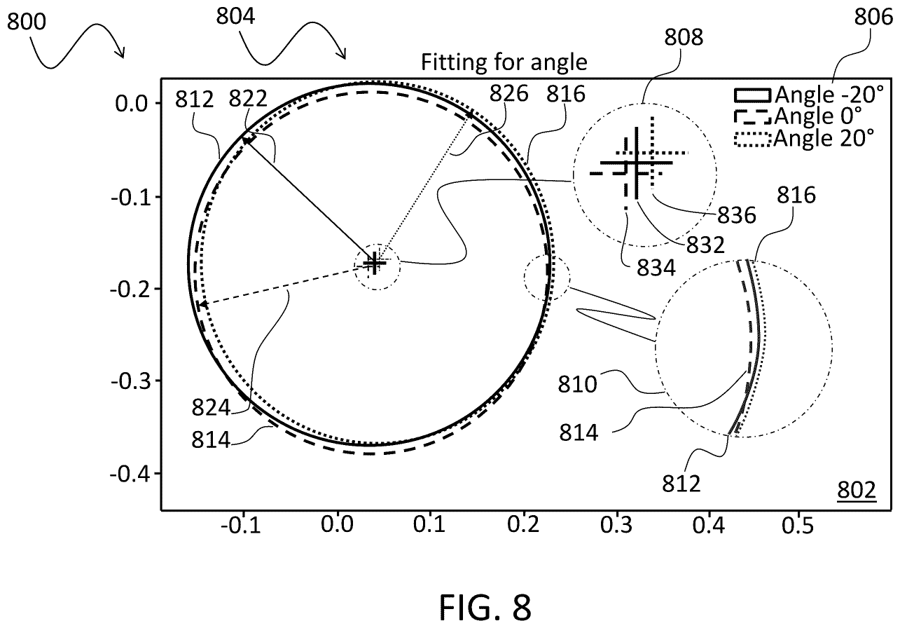

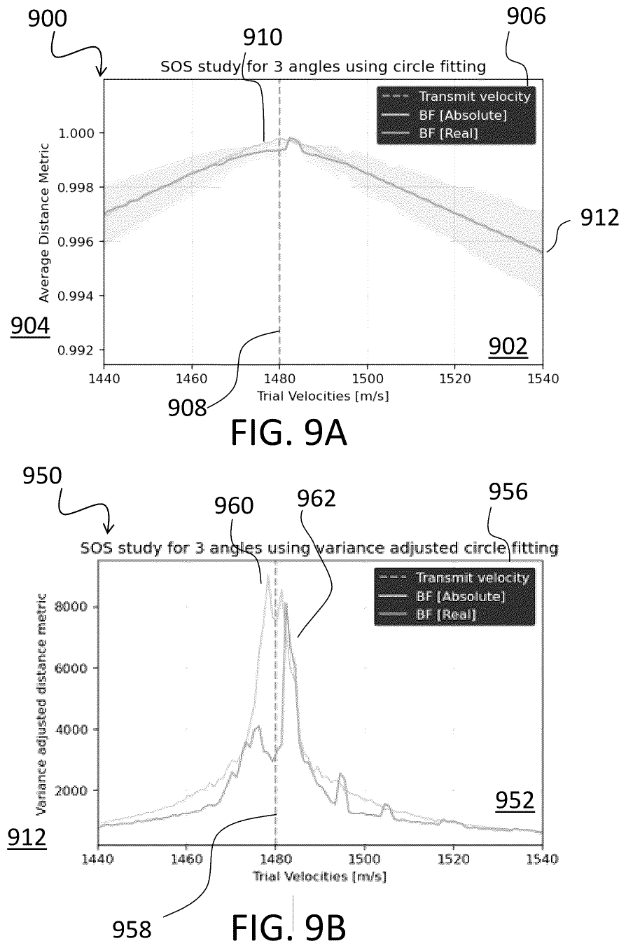

Various drawings illustrate aspects of the results of the operation of a probe and a processor-based device in accordance with embodiments of the invention. FIG. 8 illustrates examples of geometric features of extracted from an image. FIG. 9 illustrates examples of deviation metrics over a plurality of trial values for the speed of sound.

Turning to FIG. 1. In some embodiments, probe 100 is used to capture images and other physical measurements of material surrounding probe 100, such as a tubular-e.g., casings, conduits, junctions, liners, pipes, tubulars, valves, and the like, in situ. FIG. 1 illustrates probe 100, including a transducer array which in operation provides images of material surrounding probe 100. In some embodiments, probe 100 includes, at a distal end, a head 102 coupled to a first body 104; and an imager frame or imager housing 106 coupled to first body 104 and electronics bay 108. In some embodiments, probe 100 includes a second body 110 coupled to electronics bay 108. Probe 100 may have further components before a proximal end 112. Probe 100 may be coupled to wireline 114 to move the probe through the tubular.

In some embodiments, head 102 is shaped for probe 100 to traverse a passage e.g., a passage including a fluid. Head 102 may be a shaped mass or include instruments such as a forward-looking imager. In some embodiments, head 102 is coupler to another tool (not shown), e.g., various tools or probes are daisy-chained.

In some embodiments, probe 100 includes a plurality of centralizers, which extend from probe 100 and, in normal operation, abut the inner surface of the tubular. A centralizer is a device used to bias to a middling position or centralize a piece of equipment, such as probe 100. For example, a centralizer may position a device in a middling position within a casing. The plurality of centralizers includes one or more springs to bias probe into the middle of the surrounding material. In some embodiments, probe 100 includes a first plurality of centralizers 120 including two vanes per centralizer. Plurality of centralizers 120 includes centralizer 120A, centralizer 120B and the like spaced apart in the azimuthal, e.g., evenly spaced apart, unevenly spaced, pairs in opposite directions with even intra pair spacing and (un)even inter pair spacing. In some embodiments, centralizer 120A is opposite centralizer 120C.

One or more centralizers in plurality of centralizers 120 may be in contact with an enclosure 150. Examples of enclosures include casings, conduits, junctions, liners, pipes, tubulars, valves, and the like, in situ. A tubular is a body in the form of a pipe or tube. A tubular may be further characterized as round/elliptical in cross-section (e.g., cylindrical) hollow, and open at one or both ends.

In some embodiments, probe 100 includes an imager housing 106. For example, located proximal to head 102. The imager housing 106 includes an ultrasound transducer array 130, which array may have a cylindrical shell shape (e.g., ring, band, barrel, or collar) or a truncate frustum. The imager housing 106 includes a plurality of transducer elements distributed circumferentially in an array, and operable as a phased array.

In some embodiments, the transducer array 130 is a radial imager transducer array that emits acoustic waves in a plurality of directions at or near right angles to the principal axis of probe 100. In some embodiments, transducer array has a cylindrical shell shape.

In some embodiments, transducer array includes 32 to 2048 transducers arranged in an annular shape. The transducer array more preferably includes 128 to 512 transducers. In some embodiments, the transducer array includes 384 transducers. The transducer array operates in a frequency of 0.1 to 30 MHz, and more preferably 1 to 10 MHz. In some embodiments, transducer array operates at 5 MHz. Transducer array may include piezoelectric composites, such as lead zirconate titanate (PbZT), or compositions of bismuth scandium oxide and lead(II) titanate such as 0.36BiScO3−0.64PbTiO3. In some embodiments, the transducers are Piezoelectric Micromachined Ultrasonic Transducers (PMUT).

In some embodiments, electronics bay 108 is proximally disposed and coupled to imager housing 106. In some embodiments, electronics bay 108 includes suitable electronic components for probe 100, such as a power supply (e.g., battery, transformer, wire to external supply), a communication system, an image processor, an inertial measurement unit, and a data logger. Electronics bay 108 may include suitable electronics that in response to control signals, e.g., generated by a microcontroller executing processor-executable instructions, transmit and receive ultrasound pulses, adjust the absolute or relative time of transmissions, modulate transmissions, convert analog signals into digital signals, record data, and process the received pulses. The electronics in electronics bay 108 can run in one or more modes including a plurality of modes at the same time such as B-mode (brightness mode) to obtain an image of the surrounding structures or D-mode (Doppler mode) to obtain information on fluid flow. The electronics preferably generates transmit delay signals to the ultrasound array calculated to transmit the pulse as a plane wave, such that the target is insonified over a wide, unfocused area. The plane wave may take the form of an arc in the case where the target has a curved shape, such as the elliptical/circular shape of a tubular.

Turning to FIG. 2. which illustrates probe 200, including plural transducer arrays 230A-C, each of which in operation provides images of an arc section of the tubular. In some embodiments, probe 200 includes, at a distal end 202 coupled to a first body 204; and an imager housing 206 coupled to first body 204. In some embodiments, probe 200 includes an electronics bay (not shown) coupled to imager housing 206. Imager housing 206 includes sensor arms 216 that are biased to extend the attached transducer arrays 230 away from the housing and into abutting the tubular. In embodiments, sensor arms 216 include sensors for providing sensor arm displacement values with respect to an imaging housing 206. In some embodiments, each of the one or more transducer arrays 230A-C include one or more spacing elements, such as wheels 250, which abut the inner surface of the tubular and maintain a constant standoff distance from each array 230A-C to said inner surface. Probe 200 may have further components as shown on the drawing sheet.

In some embodiments, probe 200 includes a plurality of transducer arrays 230, for example, array 230A, array 230B, and so on. In some embodiments, each array is posed differently than another representative array. For example, the sensor arms and their arrays may be spaced apart on the major axis of probe 200, with a different azimuthal position, or with a tilt. The directions used here are shown on the rose 240 in FIG. 2. Herein, r denotes the radial position from the origin, e.g., a point on a probe. The azimuthal direction is θ. Herein, z is parallel to the major axis of the probe with distal being positive. These form a cylindrical coordinate system (r, θ, z). Rose 240 includes a sector 242-A including a plurality of connected azimuthal values. As shown on rose 240 a cartesian system (e.g., right-handed) can be also used where x is in zero of the azimuthal values.

The wavefront transmitted by transducer array(s) may be described as ‘coherent,’ ‘weakly focused,’ ‘defocused,’ ‘unfocused,’ ‘plane wave’, ‘spherical’, ‘spiral’, ‘divergent,’ or ‘non-convergent’ in as much as the transmitted waves may have some theoretical focal point within or behind the transducer. The transmitted waves may be a plane or curved wavefront, the former having a flat front and the latter having a front that is substantially curved or arc-shaped. Curved/arc-shaped waves can be seen as the polar coordinate equivalent of planar waves. The transmitted wavefront from the transducer towards a curved target, such as a pipeline or casing, can be an arc, rather than a flat plane wave. These shapes are created by phase delays of the pulses emitted by each transducer element. Notably, these fronts do not converge or focus on the surface of the target but rather strike the surface of the target at an angle of incidence with respect to the normal of the surface. Preferably, a curved wavefront hits the inside of a tubular target at the same angle of incidence relative to the normal of the surface of the tubular along the whole area of sonification. In embodiments, multiple wavefronts with multiple transmission angles are used to generate multiple corresponding images of an at least partially overlapping region of the target object.

In some embodiments, probe 200 includes a plurality of centralizers 224 which extend from probe 200 and, in normal operation, abut the inner surface of the tubular. For example, centralizer 224A and centralizer 224B may position probe 200 within the center of a casing or pipeline, while the probe moves and wobbles therethrough.

FIG. 3 illustrates a schematic view of aspects of probe in accordance with some embodiments of the invention. In some embodiments, probe 100 includes a plurality of circuits 300.

The plurality of circuits 300 includes a control subsystem that includes at least one processor 302, at least one input/output (I/O) device 304, and at least one bus 306 to which, or by which, at least one processor 302 and I/O device(s) 304 are communicatively coupled.

At least one processor 302 may be any logic processing unit, such as one or more microprocessors, central processing units (CPUs), digital signal processors (DSPs), graphics processing units (GPUs), application-specific integrated circuits (ASICs), programmable gate arrays (PGAs), programmed logic units (PLUS), and the like. Processor(s) 302 may be referred to in the singular, but may be two or more processors.

In some embodiments, I/O device(s) 304 includes one or more user interface input devices, such as a display a keyboard, a mouse, a microphone, and a camera. The one or more user interface input devices may be detachable. In some embodiments, I/O device(s) 304 includes one or more output devices, such as displays, speakers, and lights. In some embodiments, I/O device(s) 304 is a single light. The one or more output devices may be detachable. The input/output device(s) 304 may include one or more sensors (e.g., transducers, thermometers, force sensors, strain gauge, clock) and output devices (e.g., actuators, displays, lights).

The plurality of circuits 300 includes a network interface subsystem 308 communicatively coupled to bus(es) 306 and provides bi-directional communication to other systems (e.g., a system external to plurality of circuits 300) by one or more network or non-network communication channel(s) (e.g., cable 114). Network interface subsystem 308 includes circuitry. Network interface subsystem 308 may use communication protocols (e.g., FTP, HTTP, Web Services, and SOAP with XML) to effect bidirectional communication of information including processor-readable data, and processor-executable instructions.

The plurality of circuits 300 includes at least one nontransitory computer-or processor-readable storage device 310 coupled to bus(es) 306. The at least one nontransitory computer-or processor-readable storage device 310 includes at least one nontransitory storage medium. In some embodiments, storage device(s) 310 includes two or more distinct devices. Storage device(s) 310 can, for example, include one or more volatile storage devices, for instance, random access memory (RAM), and one or more non-volatile storage devices, for instance read only memory (ROM), flash memory, magnetic hard disk (HDD), optical disk, solid state disk (SSD), and the like. A person of skill in the art will appreciate storage device(s) 310 may be implemented in a variety of ways such as a read-only memory (ROM), random access memory (RAM), a hard disk drive (HDD), a network drive, flash memory, digital versatile disk (DVD), any other forms of computer-readable memory or storage medium, and/or a combination thereof. Storage device(s) 310 can be read only or read-write as needed. Further, modern computer systems and techniques conflate volatile storage and non-volatile storage, for example, caching, using solid-state devices as hard drives, in-memory data processing, and the like. At least one storage device 310 may store on or within the included storage media processor-readable data, and/or processor-executable instructions.

The plurality of circuits 300 includes one or more power supplies 312. In some embodiments, for example, power supply (ies) 312 are an external power supply (e.g., coupled through e 114). In some embodiments, power supply (ies) 312 are an on-board power source(s), and could be located in electronics bay 108. The on-board power sources can, for example, include one or more batteries, ultra-capacitors, or fuel cells, to independently power different components of probe 100 or plurality of circuits 300.

The plurality of circuits 300 includes at least one transducer array 314. In response to processor-executable instructions, transducer array (ies) 314 emits ultrasonic signals. These signals may be reflected or refracted by one or more tubulars to create echoes, returns or reflections, which are received by transducer array (ies) 314. Examples of transducer array (ies) 314 are described herein including above including one or more transducer arrays 230.

Storage device(s) 310 include or store processor-executable instructions and/or processor-readable data 320 associated with the operation of plurality of circuits 300, probe 100, and the like. In some embodiments, the processor-executable instructions and/or processor-readable data include a basic input/output system (BIOS) 322, an operating system 324, drivers 326, communication instructions and data 328, input instructions and data 330, beamformer instructions and data 332, picker instructions and data 334, analyzer instructions and data 336, and the like.

Exemplary operating systems 324 include ANDROID®, LINUX®, and WINDOWS®. The drivers 326 include processor-executable instructions and data that allow processor(s) 302 to control one or more components in plurality of circuitry 300. The processor-executable communication instructions and data 328 include processor-executable instructions and data to implement communications between plurality of circuits 300 and another processor-based device through network interface subsystem 308.

The processor-executable input instructions or data 330, when executed, direct plurality of circuits 300 to process input from I/O device(s) 304, transducer array (ies) 314, or sensors included in a wider system, information that represents input stored on or in a storage device, e.g., storage device(s) 310. In some embodiments, the processor-executable input instructions or data 330, when executed, direct plurality of circuits 300 to provide a value of the speed of sound based on input from a thermometer. The value may be part (e.g., an inner value) of a plurality of trial values for the speed of sound. For example, processor(s) 302 may transform input from a thermometer, e.g., from probe 100, by a quadratic velocity correction formula such as

$$1403.4 + 4.7 T - 004 {T}^{2} ( m / s )$$

Similar formulas exist for different fluids, and for some common fluids with adjustments for pressure and purity. For example, water has a quadratic adjustment for temperature, cubic for salinity, and quartic for pressure. Thus Applicants appreciate the merit of searching over a plurality of values.

In some embodiments, the processor-executable input instructions or data 330, when executed, direct plurality of circuits 300 to provide and/or transform information for output. For example, emit an ultrasonic signal in one or more modes including B-mode or D-mode.

The processor-executable beamformer instructions or data 332, when executed, direct plurality of circuits 300 to process input from I/O device(s) 304, transducer array (ies) 314, sensors included in a wider system, or information that represents input stored on or in storage device(s) 310. The processor-executable beamformer instructions or data 332, when executed, direct plurality of circuits 300 to transform information characterizing reflections into one or more images. Beamformer instructions or data 332, when executed, filter out spurious reflections from information characterizing reflections. In some embodiments, beamformer instructions 332 includes processor-executable instructions that, when executed, generate visual representations of the physical distribution of acoustic signals (e.g., reflections) and may encode information like signal strength.

The processor-executable picker instructions or data 334, when executed, direct plurality of circuits 300 to identify geometric shapes in a plurality of images of the tubular. Examples of geometric parameters of a target include one or more of a center of a tubular, a curvature of a tubular, and the interior dimension of a tubular. The plurality of images may be provided by beamformer instructions or data 332 based on information from probe 100, I/O device(s) 304, transducer array (ies) 314, or sensors included in a wider system. In some embodiments, picker instructions or data 334 includes processor-executable instructions that, when executed, identify or pick one or more geometric parameters that define the shape of the tubular, for example, the interior dimension of a tubular. A tubular may be treated as circular or elliptical (in cross-section), and these shapes can be parameterized by radius, Xcenter, Ycenter, aspect ratio parameters. Higher order formulas (splines, parabolas, etc.) may be used to define the tubular and this requires addition processing power to fit the data.

The processor-executable analyzer instructions or data 336, when executed, direct plurality of circuits 300 to process input characterizing a plurality of images to determine a shape of the tubular. Analyzer instructions or data 336, when executed, may direct plurality of circuits 300 to process information from probe 100, I/O device(s) 304, transducer array (ies) 314, or sensors included in a wider system. Analyzer instructions or data 336, when executed, may direct plurality of circuits 300 to process information generated by picker instructions or data 334. In some embodiments, analyzer instructions or data 336 includes processor-executable instructions that, when executed, extract the speed of sound data for one or more media. In some embodiments, analyzer instructions or data 336 includes processor-executable instructions that, when executed, select one or more images based on the speed of sound data.

In some embodiments, one or more of processor-executable instructions 320 are executed by at least one processor in a system principally contained off-board of probe 100. For example, a system includes a control subsystem that includes at least one processor, at least one input/output (I/O) device, a network interface subsystem, a tangible nontransitory computer-or processor-readable storage device, and at least one bus to which the proceeding are coupled. The processor(s) may execute processor-executable beamformer instructions or data, picker instructions or data, or analyzer instructions or data.

Turning to FIG. 4 which illustrates an example method 400 for use with a probe such as a probe including an ultrasonic array. Various embodiments of probe are described herein including in relation to FIG. 1 through FIG. 3. For example, see probe 100.

FIG. 4 shows method 400 is executable by a controller, such as circuitry or at least one hardware processor, for the operation, or improvement in the operation, of a probe including an ultrasonic array. Method 400, in part, describes how a controller may determine the speed of sound of media proximate to the probe, and, optionally, create data characterizing tubulars proximate to the probe.

Those of skill in the art will appreciate that other acts may be included, removed, and/or varied or performed in a different order to accommodate alternative implementations. Method 400 is described as being performed by a controller, for example, a controller subsystem or processor(s) 302 in plurality of circuits 300 in conjunction with other components, such as transducer array (ies) 314. However, method 400 may be performed by multiple controllers or by another system. For example, the method may be performed by a computer separate from the probe or may be cloud computing.

For performing part or all of method 400, the controller may be at least one hardware processor. A hardware processor may be any logic processing unit, such as one or more microprocessors, central processing units (CPUs), digital signal processors (DSPs), graphics processing units (GPUs), application-specific integrated circuits (ASICs), programmable gate arrays (PGAs), programmed logic units (PLUS), and the like. The hardware processor may be referred to herein by the singular, but may be two or more processors. See for example processor(s) 302.

The hardware processor(s) may, for example, execute one or more sets of processor-executable instructions and/or data stored on one or more nontransitory processor-readable media. See for example processor-executable instructions and/or processor-readable data 320 stored on device(s) 310. The hardware processor(s) may, for example, execute one or more of input instructions and data 330, beamformer instructions and data 332, picker instructions and data 334, or analyzer instructions and data 336.

Method 400 begins, for example, in response to an invocation by the controller. At 402, the controller receives data characterizing a plurality of reflections off the walls of a tubular. The plurality of reflections corresponds to a plurality of ultrasonic pulses sent in a plurality of directions. At least one respective reflection in the plurality of reflections corresponds to a first direction in the plurality of directions. In some implementations, the waves generated by the ultrasonic pulses overlap over the same region of the tubular target.

At 404, the controller selects a plurality of values for the speed of sound. For example, the controller may select a range stored as processor-readable data. For propagation of sound in water a suitable range for the plurality of values for the speed of sound may be 1440 m/s to 1540 m/s. A wider SoS range may be needed for hydrocarbons, which may include crude oil, diesel, LNG and mixtures of hydrocarbons. In some implementations, the controller selects a range and starting trial speed provided by the user through a User Interface. In some implementations, the controller selects a plurality of values for the speed of sound corresponding to known speeds for the liquid proximate to the probe or may select a recently computed value for the speed of sound. The controller can select a range of values surrounding an initial value based on one or more of a temperature value and a pressure value provided by probe 100 or one or more coupled sensors.

At 406, the controller, for at least two values of the speed of sound in the plurality of values for the speed of sound, beamforms the reflection data to create a plurality of images, where an image corresponds with a direction in the plurality of directions and value of the speed of sound. In embodiments, the plurality of images includes subsets of multiple images that correspond with a same direction in the plurality of directions and a value of the speed of sound, the multiple images corresponding to images from reflections received at different ones of the transducer arrays. At 406, in some embodiments, the controller accepts a plurality of samples that may be arranged as multi-dimensional data, e.g., array. For example, a first index corresponds to a transducer in the plurality of transducers. Associated with this transducer (and index) is a spatial location. A second index corresponds to the sample (e.g., inverse of eight times the carrier frequency) and thus signals at the second index show the time of flight of a reflection.

At 406, in some embodiments, the controller computes for each location in the index space a delay value for each value of the plurality samples. Each delay value may be based on the speed of sound plus the transmit location, tubular location, and receive location. Note the transmit and receive locations may differ because of motion or crosstalk.

At 408, the controller extracts from the plurality of images a plurality of geometric parameters for the tubular. In some implementations, the controller extracts from the plurality of images a spatially varying geometric parameter of the tubular and a spatially invariant geometric parameter of the tubular. In some embodiments, the controller extracts the plurality of geometric parameters further based on one or more sensor arm displacement values provided by one or more coupled sensors. In additional embodiments, the controller extracts the plurality of geometric parameters further based on multi-dimensional data, as described above, for extracting global values for the plurality of geometric parameters for each given trial value for a speed of sound, using in this manner samples from a plurality of transducers and their corresponding relative locations. An example of a spatially varying geometric parameter is the x-coordinate of the center of a tubular. An example of a spatially invariant geometric parameter is the radius of a tubular.

At 410 the controller computes a deviation metric amongst the plurality of geometric parameters. For example, the controller characterizes how different the images are based on the geometric parameters. In some implementations, the deviation metric is an average (e.g., mean, arithmetic mean, geometric mean) of a pairwise metric applied to the extracted parameters. Examples of the pairwise metric include a metric proportional to the differences in the spatially variant parameters. For example, differences in the position of the center of a circular enclosure. Other examples of the pairwise metric include a metric inversely proportional to the combined value of the spatially invariant parameters. For example, the sum of the radii extracted from each case. In some implementations the pairwise metric D(θ₁, θ₂) is proportional to

$${[ {( {x}_{2} - {x}_{1} )}^{2} + {( {y}_{2} - {y}_{1} )}^{2} ]}^{1 / 2}$$

In some implementations, the pairwise metric D(θ₁, θ₂) is proportional to

$$\frac{{[ {( {x}_{2} - {x}_{1} )}^{2} + {( {y}_{2} - {y}_{1} )}^{2} ]}^{1 / 2}}{{r}_{1} + {r}_{2}}$$

Where r is radius, x and y are cartesian positions for the center and the subscripts are for different images based on different transmit angles.

In some implementations, the deviation metric D̅ is proportional to an average of a pairwise metric applied to the extracted parameters. For example, proportional to

$$\frac{1}{N} {\sum }_{i , j} D ( {θ}_{i} , {θ}_{j} )$$

Here i and j are angles and in some implementation pairs of angles, e.g., widely differing angles are excluded from the deviation metric D̅. In some implementations, the deviation metric \hat{D} is proportional to an average of a pairwise metric divided by a factor proportional to the variance in the pairwise metric values for all pairs allowed in the deviation metric. For example,

$$\frac{\overline{D}}{\frac{1}{N} {\sum }_{i , j} {( \overline{D} - D ( {θ}_{i} , {θ}_{j} ) )}^{2}}$$

Here the denominator is the variance σ² and in further implementation is the standard deviation σ, or values proportional to either.

At 412 the controller selects a value of the speed of sound that optimizes the deviation metric. In some implementations, the suitable optimization is a minimization.

At 414, optionally, the controller selects at least one image based on the optimal speed of sound value. The image may be from a preferred transmission angle. In some implementations, the controller recreates the images based on the optimal speed of sound.

In some embodiments, method 400 is repeated to determine multiple values for the speed of sound for multiple imaged regions. For example, the controller may determine a first value for the speed of sound in media as described above and repeat the process to characterize a second speed of sound in an object, such as the tubular or conduit, from the plurality of reflections received off the target or object at step 402.

Next, the controller selects a plurality of values for a second speed of sound similarly to step 404, and corresponding to the speed of sound in the target or object. For example, a suitable range for the second speed of sound for a steel object may be 5600 m/s to 6300 m/s. The controller sets the speed of sound for the media based on the previously determined speed of sound value as selected in 412,

Then, the controller, for the plurality of values for the second speed of sound creates a plurality of second images from the reflections where a second image corresponds with a direction in the plurality of directions, and value of the second speed of sound, similarly to 406. In some embodiments, the controller, as described above, computes for each location in the index space a delay value for each value of the plurality samples. In some embodiments, the plurality of second images are generated for regions corresponding to the object or tubular.

The controller then extracts from the plurality of second images a plurality of second geometric parameters, similar to step 408. In some implementations, the controller extracts from the plurality of second images a spatially varying geometric parameter of the tubular and a spatially invariant geometric parameter of the tubular. In some embodiments, subregions within the plurality of second images are identified, for example, each subregion corresponding to a different reverberation reflection from an object's inner diameter (ID) and outer diameter (OD), where different subsets of second geometric parameters are extracted for each subregion. In some embodiments, a single subregion within each second image is selected, the single subregion containing a first reflection of an outer diameter of the object.

Next the controller computes a second deviation metric amongst the plurality of second geometric parameters, similar to the above description in 410. For example, the controller characterizes how different the images are based on the geometric parameters, where the images are obtained from different ones of the plurality of directions.

The controller then selects a value of the second speed of sound that optimizes the second deviation metric, as in 412. In some implementations, the suitable optimization is a minimization.

Thereafter, the controller selects at least one second image based on the optimal second speed of sound value, as in 414. The at least one second image may be from a preferred transmission angle.

Turning to FIG. 5 which illustrates an example method 500 for the operation of a probe including an ultrasonic array such as those described herein including in relation to FIG. 1 through FIG. 3. Method 500 is executed by a controller, such as circuitry or at least one hardware processor, for the operation of a probe including an ultrasonic array. Method 500, in part, describes how a controller may determine the speed of sound of media proximate to the probe, and, optionally, create data characterizing tubulars proximate to the probe.

For method 500, as with other methods taught herein, the various acts may be performed in a different order than that illustrated and described. Additionally, the methods can omit some acts, combine acts, split an act, and/or employ additional acts.

Method 500, as with other methods, taught herein, may be performed by a controller, for example, a controller subsystem or processor(s) 302 in plurality of circuits 300 in conjunction with other components, such as transducer array (ies) 314. However, method 500 may be performed by multiple controllers or by another system.

Method 500 begins at 502 when the controller executes processor-executable instructions to transmit ultrasonic pulses in a plurality of directions from an ultrasonic transducer array. For example, the plurality of directions may be a plurality of azimuthal angles. In some implementations, the plurality of directions is a plurality with odd cardinality, e.g., {0, ±a₁}, {0, ±a₁, ±a₂}, {−a₂, −a₁, 0, +b₁, +b₂}, where aᵢ and bᵢ are greater than zero. In some implementations, the plurality of directions is a plurality with even cardinality, e.g., {±a₁}, {±a₁, ±a₂}, {−a₂, −a₁, +b₁, +b₂}. In some implementations, the waves generated by the ultrasonic pulses overlap over the same region of the tubular target.

At 504 the controller receives, at the ultrasonic transducer array, a plurality of reflections from at least one tubular. The plurality of reflections, also called echoes or returns, are signals that are reflected back to a transducer after transmission, e.g., after 502.

At 506 the controller generates, or receives, a plurality of trial values for the speed of sound. For the plurality of trial values for the speed of sound, the controller performs 508-516 (inclusive, even numbers only). The processor-executable instructions for 508-516 may be implemented by several control structures such as a do-while, for loop, and vectorized instructions.

At 508 the controller selects an instant trial value from amongst the plurality of trial values for the speed of sound. At 510 the controller creates a plurality of images from the reflections and the instant trail value for the speed of sound. A respective image in the plurality of images corresponds with a respective direction in the plurality of directions. Each image in the plurality of images is of the at least one tubular.

At 510 the controller engages in beamformation. This process involves providing solutions to a discretized wave equation. The wave equation is for a scalar pressure (p) value based on location (x), time (t), and source (S). In particular, if you have pressure values for locations and times you are solving for the source values. All solutions depend on the value of the speed of sound (c).

$${∇}^{2} p ( x , t ) - \frac{1}{{c}^{2}} \frac{{\partial }^{2}}{\partial {t}^{2}} p ( x , t ) = S ( x , t )$$

In embodiments, multiple values for the speed of sound (c) are used for multiple regions within the plurality of images, corresponding to locations of different materials such as one or more of a medium and an object.

At 512 the controller extracts from the plurality of images a plurality of geometric parameters for the tubular. For example, the controller extracts a spatially varying geometric parameter of the tubular and a spatially invariant geometric parameter of the tubular. In some embodiments, the controller extracts the plurality of geometric parameters further based on one or more sensor arm displacement values provided by one or more coupled sensors. In additional embodiments, the controller extracts the plurality of geometric parameters further based on multi-dimensional data, as described above, for extracting global values for the plurality of geometric parameters for each given trial value for a speed of sound, using in this manner samples from a plurality of transducers and their corresponding relative locations. The controller may extract the position of the center of a circular tubular (variant) and the radius of the tubular (invariant).

At 514 the controller computes a deviation metric amongst the plurality of geometric parameters. Suitable deviation metrics are described herein above in relation to, at least, FIG. 4.

At 516 the controller checks if method 500 is in or has met a termination condition. In some implementations, termination is based, at least in part, on run-time. In some implementations, termination is based, at least in part, on operating on a suitable number of values in the plurality of values for the speed of sound have been tested. In some implementations, all trial values in the plurality of values have been tested or skipped, e.g., adaptive step sizes are used, before termination. If 516-No, then continue processing at 508. If 516-Yes, then continue at 518.

At 518, in some implementations, the controller normalizes the average deviation by the variance of the deviation. In some implementations, the controller computes an average value of a plurality of pairwise deviation metrics, e.g., the plurality of deviation metrics created in 508-514. The average value may be used as a value to optimize over a plurality of trial values of the speed of sound. In some implementations, the controller computes a value proportional to the standard deviation value of the plurality of pairwise deviation metrics, e.g., standard deviation, or variance. The controller divides the average value of the plurality of pairwise deviation metrics by the value proportional standard deviation value of the plurality of pairwise deviation metrics. The normalized value or quotient may be used as a value to optimize over a plurality of trial values of the speed of sound. At 518, in some implementations, the controller selects at least one image based on the optimal speed of sound value.

At 520, the controller returns an optimal value for the speed of sound from the plurality of values. The optimal value is the value that optimizes the deviation metric. At 520, in some implementations, the controller selects at least one image based on the optimal speed of sound value for the deviation metric, average pairwise deviation metric, or normalized deviation metric.

In some embodiments, method 500 is repeated for multiple regions to select multiple values for the speed of sound, for example, for a medium proximal to the probe and for an object proximal to the probe.

Turning to FIG. 6 which illustrates an example method 600 for the operation of a probe including an ultrasonic array such as probe 100. Method 600 is executable by a controller, such as circuitry or at least one hardware processor, for the operation of a probe including an ultrasonic array. Method 600, in part, describes how a controller may determine the speed of sound of media proximate to the probe, and, optionally, create data characterizing tubulars proximate to the probe, e.g., images.

Method 600 begins at 602. The controller acquires reflection data for a plurality of angles. For example, probe 100 receives at an ultrasonic transducer array a plurality of reflections from the tubular. In some implementations, the reflection data for the plurality of angles arrives from an overlapping region of the tubular target.

At 604, optionally, the controller executes processor-executable instructions to pre-process the reflection data. In some implementations, the controller extracts the real part of the signal, the imaginary part, the magnitude, or the phase information. In some implementations, at 604 the controller excludes reflections corresponding to an unlikely time of flight, e.g., a short time of flight, or a long time of flight. In some implementations, the controller excludes reflections corresponding to multiple echoes. In some implementations, at 604, the controller applies an amplitude filter, for example, to eliminate spurious spikes that correspond to reflections that occur away from the inner wall.

Method 600 continues in a semi-parallelized plurality of iterations over 606-618 (inclusive, even numbers only) which may be implemented in different ways such as do-while, for-loop, or vectorized instructions. At 606 the controller selects a trial value for the speed of sound (vₜ) from amongst a plurality of trial values for the speed of sound. At 608 the process forks.

At 610-1, the controller creates a first image (I₁) including a representation of an tubular based on reflection data corresponding to the first angle (I₁). At 610-N, the controller creates an nth image (I_{N}) including the tubular for the nth angle (θ_{N}). The controller can compute an intermediary image (Iᵢ) for an intermediary angle (θᵢ)—not shown. In some embodiments, each of the images (I) include a plurality of images based on reflection data from a plurality of transducers for each corresponding angle.

At 612-1, the controller extracts a first plurality of geometric parameters (L₁) from the first image (I₁). At 612-N, the controller extracts a nth plurality of geometric parameters (Lₙ) from the nth image (I_{N}). The controller can extract an immediate plurality of geometric parameters (Lᵢ) from the intermediary image (Iᵢ)—not shown. In some embodiments, the controller extracts the plurality of geometric parameters (L) further based on one or more sensor arm displacement values provided by one or more coupled sensors. In additional embodiments, the controller extracts the plurality of geometric parameters (Lᵢ) further based on a plurality of images based on reflection data from a plurality of transducers for each corresponding angle. Method 600 continues at join 614. In some embodiments, at least between fork 608 and join 614 method 600 runs in parallel.

At 616 the controller excludes pairwise comparisons that corresponds to incompatible angles. The incompatible angles could be acute, obtuse or reflex angle that correspond to directional differences over a threshold. For example, first respective direction (e.g., −20°) is incomparable with a second respective direction (e.g., +20°). The first respective direction (e.g., −20°) and the second respective direction (e.g., +20°) are comparable with a third direction (e.g., 0°).

At 618 the controller computes error in fit amongst the plurality of geometric parameters. For example, the controller may compute a deviation metric described above between pairs of angles. In some implementations, the controller aggregates over the permissible or comparable pairs of angles.

At 620 the controller checks if method 600 is in or has met a termination condition. Suitable termination thresholds are described above. If 620-No, then continue processing at 606. If 620-Yes, then continue at 622.

At 622, the controller returns an optimal speed of sound value.

In some embodiments, method 600 is repeated for multiple regions to select multiple values for the speed of sound, for example, for a medium proximal to the probe and for an object proximal to the probe.

Turning to FIG. 7A which illustrates an example method 700 for the operation of a probe including an ultrasonic array such as probe 100. Method 700 is executable by a controller, such as circuitry or at least one hardware processor, for the operation of a probe including an ultrasonic array. Method 700, in part, describes how a controller may determine the speed of sound of media proximate to the probe in a plurality of directions and locations.

In some embodiments, the speed of sound may be isotropic varying with direction, e.g., up down, left, right. The present disclosure uses direction to refer to transmit angles. Direction also refers to the sector. A sector includes a plurality of connected azimuthal values, see for example a sector 242-A in FIG. 2. In some implementations, two or more instances of methods 400, 500, or 600 can be performed for a plurality of sectors.

In some embodiments, the speed of sound may vary with location or time. In some implementations, two or more instances of methods 400, 500, or 600 can be performed for a plurality of times. If an instrument moves then a respective plurality of instances of methods 400, 500, or 600 can provide a plurality of values for the speed of sound varying by location.

Method 700 begins at 702. The controller executes processor-executable instructions to transmit ultrasonic pulses in a plurality of directions from an ultrasonic transducer array towards a tubular in a sector. For example, the plurality of directions may be all withing a plurality of azimuthal angles.

At 704 the controller receives, at the ultrasonic transducer array, a plurality of reflections from at least one target or the target in the sector. An example of a sector is shown in, at least, FIG. 2.

The controller acquires reflection data for a plurality of angles. For example, probe 100 receives at an ultrasonic transducer array a plurality of reflections from at least one tubular.

At 706 the controller checks if method 700 is in or has met a termination condition. If 706-No, then continue processing at 702. If 706-Yes, then method 700 ends and processing can continue in one or more instances of methods 400, 500, or 600.

Turning to FIG. 7B which illustrates an example method 750 for the operation of a probe including an ultrasonic array such as probe 100. Method 750 is executable by a controller, such as circuitry or at least one hardware processor, for the operation of a probe including an ultrasonic array. Method 750, in part, describes how a controller may determine the speed of sound of media proximate to the probe in a plurality of directions locations.

In some embodiments, the speed of sound may vary with location or time. In some implementations, two or more instances of methods 400, 500, 600, or 600 can be repeated. As the probe moves, a respective plurality of instances of methods 400, 500, 600, or 700 can provide a plurality of values for the speed of sound varying by location. The SoS may vary along the tubular (along the Z-axis) or azimuthally around the probe (e.g. lighter fluids tend to rise above the probe).

Method 750 begins at 752. The controller executes processor-executable instructions to optionally move the probe. At 754 the controller receives, at the ultrasonic transducer array, a plurality of reflections from at least one target. At 756 the controller checks if method 750 is in or has met a termination condition. If 706-No, then continue processing at 702. If 756-Yes, then method 750 ends and processing can continue in one or more instances of methods 400, 500, 600, or 700.

FIG. 8 illustrates examples of geometric features extracted from an image formed from reflections received by a probe such as probe 100. Graphic user interface 800 includes a plot 802, a plurality of geometric features 804, and a legend 806.

Two areas of plot 802 are highlighted and shown in enlarged view in FIG. 8. A first area 808 show a plurality of centers of a tubular. A second area 810 shows a plurality of different circumferences of a tubular.

As shown in FIG. 8 the plurality of geometric features 804 includes a first set of features, a second set of features, and a third set of features. Each set of features corresponds to a different transmit direction. When the optimal value of the speed of sound is used to create the images from which the geometric features 804 are extracted the first set of features, second set of features, and third set of features are maximally aligned.

The first set of features includes a first circumference 812, a first radius 822, and a first center 832. The first radius 822 is an example of a spatially invariant feature. The first center 832 and first circumference 812 are spatially variant. The second set of features including a second circumference 814, a second radius 822, and a second center 834. The third set of features including a third circumference 814, a third radius 822, and a third center 834.

When the optimal value of the speed of sound is used to create the images the transmit angle has less effect on the plurality of geometric features 804. For example, first circumference 812, second circumference 814, and third circumference 816 are more aligned. For example, first center 832, second center 834, and third center 836 are more aligned.

FIG. 9A illustrates a first example of a deviation metric over a plurality of trial values for the speed of sound. Graphic user interface 900 includes a plot 902, a plurality of values for the deviation metric 904, and a legend 906. The deviation metric shown is an average value of a plurality of pairwise deviation metrics.

As indicated in legend 906 the known transmit velocity is show as a vertical reference line 908. The legend 906 indicates a first plurality of values for a deviation metric 910 is based on the absolute values the beamformed image, values proportional to the modulus of the real and imaginary parts. A second plurality of values for the deviation metric 912 is based on the real values the beamformed image. Both the first plurality of values 910 and the second plurality of values 912 are optimal (e.g., peak) near the transmit velocity indicated by reference line 908.

In some embodiments, the controller computes a deviation metric of a plurality of geometric parameters based on a first respective direction in a plurality of directions and a second respective direction in the plurality of directions. The first respective direction and the second respective direction are comparable. For example, the directions are 0° and +20° but not −20° and +20°. In some embodiments, the controller records a plurality of pairwise deviation metrics. A respective pairwise deviation metric is based on a first respective direction in the plurality of directions and a second respective direction in the plurality of directions. The controller computing an average value of the plurality of pairwise deviation metrics—e.g., mean, geometric mean.

FIG. 9B illustrates a second deviation metric over a plurality of trial values for the speed of sound. Graphic user interface 950 includes a plot 952, a plurality of values for deviation metric 954, and a legend 956. The deviation metric shown is a variance normalized average value of a plurality of pairwise deviation metrics.

As indicated in legend 956, the known transmit velocity is show as a vertical reference line 958. The plurality of values for the second deviation metric 954 includes a first plurality of values for the second deviation metric 960 based on the absolute values the beamformed image. The plurality of values for the second deviation metric 954 includes a first plurality of values for the second deviation metric 962 based on the real values the beamformed image. Both the first plurality of values 960 and the second plurality of values 962 are optimal near the transmit velocity indicated by reference line 908.

For methods taught herein, the various acts may be performed in a different order than that illustrated or described. Additionally, the methods can omit some acts, combine acts, split an act, and/or employ additional acts. For methods taught herein, the various acts may be performed by one or more circuits, for instance, one or more hardware processors.

The word “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about”, “approximately”, or “near” a number, or to being “substantially” equal to a number, means being within +/−10% of that number.

While the disclosure has been described in connection with specific embodiments, it is to be understood that the disclosure is not limited to these embodiments, and that the skilled person may carry out alterations, modifications, and variations of these embodiments without departing from the scope of the disclosure.

It is furthermore contemplated that any part of any aspect or embodiment discussed in this specification can be implemented or combined with any part of any other aspect or embodiment discussed in this specification.

1. A method of operation for an ultrasonic inspection system, the method comprising:
transmitting a plurality of ultrasonic pulses in a plurality of directions from an ultrasonic transducer array;
receiving a plurality of reflections from a target, wherein a respective reflection in the plurality of reflections corresponds to at least one respective pulse in the plurality of pulses;
for a plurality of trial values for a speed of sound, and until a termination condition is met, the method includes:
selecting an instant trial value from amongst the plurality of trial values for the speed of sound,
creating a plurality of images from the plurality of reflections and the instant trial value from the plurality of trial values for the speed of sound, wherein a respective image corresponds with a respective direction in the plurality of directions,
extracting from the plurality of images a plurality of geometric parameters for the target,
computing a deviation metric amongst the plurality of geometric parameters; and
returning an optimal value for the speed of sound from amongst the plurality of trial values for the speed of sound, wherein the optimal value for the speed of sound optimizes the deviation metric.

2. The method of claim 1 further comprising checking of the termination condition is met.

3. The method of claim 1 further comprising returning at least one of: the plurality of reflections from the target, the plurality of trial values for the speed of sound, the plurality of images, and the plurality of geometric parameters.

4. The method of claim 1, wherein extracting from the plurality of images a plurality of geometric parameters for the target, further comprises:
extracting from the plurality of images a spatially varying geometric parameter of the target and a spatially invariant geometric parameter of the target.

5. The method of claim 4, wherein the target is a tubular, and the method further comprises:
extracting from the plurality of images a center of the target and a curvature of the target.

6. The method of claim 1 further comprising pre-processing the plurality of reflections by at least one operation selected from the group consisting of:
extracting a real part of at least one reflection in the plurality of reflections,
extracting an imaginary part of at least one reflection in the plurality of reflections,
extracting an absolute value of at least one reflection in the plurality of reflections,
extracting a phase of at least one reflection in the plurality of reflections,
excluding at least one reflection in the plurality of reflections which corresponds to a short time of flight,
excluding at least one reflection in the plurality of reflections which corresponds to a long time of flight,
excluding at least one reflection in the plurality of reflections which corresponds to a multiple echo, and
adjusting an amplitude of at least one reflection in the plurality of reflections.

7. The method of claim 1, wherein computing a deviation metric amongst the plurality of geometric parameters, further comprises:
computing the deviation metric of the plurality of geometric parameters based on a first respective direction in the plurality of directions and a second respective direction in the plurality of directions, wherein the first respective direction and the second respective direction are comparable.

8. The method of claim 1 further comprising:
recording a plurality of pairwise deviation metrics, wherein a respective pairwise deviation metric is based on a first respective direction in the plurality of directions and a second respective direction in the plurality of directions; and
computing an average value of the plurality of pairwise deviation metrics.

9. The method of claim 8 further comprising:
computing a standard deviation value of the plurality of pairwise deviation metrics;
dividing the average value of the plurality of pairwise deviation metrics by the standard deviation value of the plurality of pairwise deviation metrics; and
identifying the optimal value for the speed of sound from amongst the plurality of trial values for the speed of sound, wherein the optimal value for the speed of sound optimizes the quotient of the average value of the plurality of pairwise deviation metrics and the standard deviation value of the plurality of pairwise deviation metrics.

10. The method of claim 1, wherein transmitting the plurality of ultrasonic pulses in the plurality of directions from the ultrasonic transducer array is for a first sector of the target, the method further comprises:
transmitting a second plurality of ultrasonic pulses in a second plurality of directions from the ultrasonic transducer array; and
receiving a second plurality of reflections from a second sector of the target, wherein a respective reflection in the second plurality of reflections corresponds to at least one respective pulse in the second plurality of pulses.

11. The method of claim 1, wherein the plurality of trial values for the speed of sound are based on one or more of a temperature sensor value and a pressure sensor value.

12. A system for ultrasonic inspection of a target, the system comprising:
an inspection probe having an ultrasonic transducer array and on-tool processor programmed to cause the ultrasonic transducer array to:
a) transmit a first plurality of ultrasonic pulses in a first plurality of directions;
b) receive a first plurality of reflections from a first sector of the target, wherein a respective reflection in the first plurality of reflections corresponds to at least one respective pulse in the first plurality of ultrasonic pulses; and
c) store the first plurality of reflections,
and
at least one non-transitory storage device communicatively coupled to at least one processor and which stores processor-executable instructions, which cause the at least one processor to iterate over at least two trial values for a speed of sound and in each respective iteration:
i) select an instant trial value for the speed of sound from amongst the at least two trial values for the speed of sound,
ii) create a plurality of images from the first plurality of reflections and the instant trial value from the speed of sound, wherein a respective image corresponds with a respective direction in the first plurality of directions,
iii) extract from the plurality of images a plurality of geometric parameters for the first sector of the target, and
iv) compute a deviation metric amongst the plurality of geometric parameters.

13. The system of claim 12, wherein the ultrasonic transducer array is a radial imager transducer array.

14. The system of claim 12, wherein, when executed, the processor-executable instructions further cause the at least one processor to:
return a result selected from:
an optimal value for the speed of sound from amongst the at least two trial values for the speed of sound, wherein the optimal value for the speed of sound optimizes the deviation metric;
the first plurality of reflections from the target;
the at least two trial values for the speed of sound;
the plurality of images; and
the plurality of geometric parameters.

15. The system of claim 12, wherein, when executed, the processor-executable instructions further cause the at least one processor to:
extract from the plurality of images a spatially varying geometric parameter of the target, and a spatially invariant geometric parameter of the target.

16. The system of claim 15, wherein, when executed, the processor-executable instructions further cause the at least one processor to:
extract from the plurality of images a center of the target and a curvature of the target.

17. The system of claim 12, wherein, when executed, the processor-executable instructions further cause the at least one processor to:
record a plurality of pairwise deviation metrics, wherein a respective pairwise deviation metric is based on a first respective direction in the plurality of directions and a second respective direction in the plurality of directions; and
compute an average value of the plurality of pairwise deviation metrics.

18. The system of claim 17, wherein, when executed, the processor-executable instructions further cause the at least one processor to:
compute a standard deviation value of the plurality of pairwise deviation metrics;
divide the average value of the plurality of pairwise deviation metrics by the standard deviation value of the plurality of pairwise deviation metrics; and
identify the optimal value for the speed of sound from amongst the at least two trial values for the speed of sound, wherein the optimal value for the speed of sound optimizes the quotient of the average value of the plurality of pairwise deviation metrics and the standard deviation value of the plurality of pairwise deviation metrics.

19. The system of claim 12 further comprising a plurality of centralizers coupled to the frame.

20. The system of claim 12 wherein the inspection probe further including:
one or more of a temperature sensor and a pressure sensors; and
the ultrasonic transducer array coupled to the inspection probe by a sensor arm;
wherein the at least two trial values are based on one or more of a temperature sensor value and a pressure sensor value; and
extracting the plurality of geometric parameters is further based on a position of the sensor arm.
